(19) United States
(12) Patent Application Publication
(10) Pub. No.: US 2002/0071244 A1
(43) Pub. Date: Jun. 13, 2002

(54) Manufacture and installation of miniature automated teller machine

(76) Inventor: Brad Zerman, Chicago, IL (US)

Correspondence Address: WALLENSTEIN & WAGNER, LTD., 53rd Floor, 311 South Wacker Drive, Chicago, IL, 60606-6622, US

(21) Appl. No.: 09/982,588

(22) Filed: Oct. 18, 2001

Related U.S. Application Data
(60) Provisional application No. 60/252,648, filed on Nov. 22, 2000.

(51) Int. Cl. G06F 1/16

(52) U.S. Cl. 361/680

(57) ABSTRACT

A miniature automated teller machine comprising a housing having a front keypad and a rear keypad. The front and rear keypads are connected to the housing. The front keypad has a front screen attached to the front keypad, and the rear keypad has a rear screen attached to the rear keypad. A door is hingedly connected to the housing. The rear screen allows an operator of the machine to perform management functions without the management functions being viewed on the front screen by a user of the machine.

### RELATED APPLICATIONS

This application claims the benefit of U.S. provisional patent application Ser. No. 60/252,648, filed Nov. 22, 2000.

### TECHNICAL FIELD

The present invention relates to an automated teller machine (ATM) and, more particularly, to the manufacture and installation of wall-mounted miniature automated teller machines (ATMs) for mounting the ATM to and through a wall.

### BACKGROUND OF THE INVENTION

Conventional large ATMs are deployed on a floor, usually behind a wall with the front showing through the wall. For ATMs that are fully located within a customer space, thinner ATMs have been deployed since floor space is a valuable commodity and is scarce in certain retail locations. These thinner ATMs are sometimes referred to as pedestal ATMs, and can be bolted to the floor to secure it, and keep safe the money inside the ATM. However, there are still risks that the pedestal ATMs can be dislodged from the floor, and carried away. In addition, these pedestal ATMs can not be accessed by the machine owner for cash refilling, paper loading and report printing, without the owner appearing in the customer area and jeopardizing their safety when cash refilling and balancing is needed to be performed. For example, in a currency exchange, the owner would have to come out from behind a bullet proof environment to refill the cash and balance the ATM for pedestal ATMs. Accordingly, the machine owner may be robbed while refilling the ATM with cash. Alternatively, the machine owner may have to remove all patrons and close the retail location before refilling the ATM with cash, thereby losing potential business in the process.

Traditionally, miniature ATMs have not been deployed in or behind an interior wall, and have not been suspended behind such wall, without the use of any pedestal. Nor have traditional machines allowed the ATM owner or operator easy access to the rear keypad for performing management functions, such as running transaction reports or ATM cash balance reports, from inside a cashier's cage.

The present invention is provided to solve problems with such devices and others.

### SUMMARY OF THE INVENTION

The present invention provides a miniature automated teller machine (ATM). The ATM has a housing having a front keypad connected to the housing, and a rear keypad connected to the housing. The front keypad has a front screen attached to the front keypad, and the rear keypad has a rear screen attached to the rear keypad.

A door is hingedly connected to the housing. Preferably, the door includes a handle and comprises a steel reinforcement material.

Preferably, the housing includes a mounting angle attached to the housing for securing the housing within a wall. Preferably, the mounting angle is attached to each side of the housing for securing the housing within the wall. Preferably, the housing comprises a steel reinforcement material.

Preferably, the rear keypad is substantially identical to the front keypad, and the rear keypad performs substantially the same function as the front keypad. Alternatively, the rear keypad performs a substantially different function than the front keypad.

The rear screen allows an operator of the ATM to perform management functions without the management functions being viewed on the front screen by ATM cardholders.

Preferably, the rear screen is substantially identical to the front screen, and the rear screen performs substantially the same function as the front screen. Alternatively, the rear screen performs a substantially different function than the front screen.

Other features and advantages of the invention will be apparent from the following specification taken in conjunction with the following drawings.

### BRIEF DESCRIPTION OF THE DRAWINGS

FIG. 1 is a partial, front perspective view of a miniature automated teller machine (ATM) according to the present invention;

FIG. 2 is a front view of a front portion of a housing for the ATM of FIG. 1;

FIG. 3 is a rear perspective view of the ATM housing of FIG. 2, with the door in an open position;

FIG. 4 is a rear view of the ATM of FIG. 1, with the door in an open position;

FIG. 5 is a side perspective view of the ATM of FIG. 1, with the door in a substantially closed position;

FIG. 6 is a rear, top perspective view of the ATM of FIG. 1, with a mounting angle attached to the rear portion of the housing for securing the housing within a wall; and

FIG. 7 is side view of the ATM of FIG. 6, after securing the housing within the wall.

### DETAILED DESCRIPTION OF THE PREFERRED EMBODIMENT

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated.

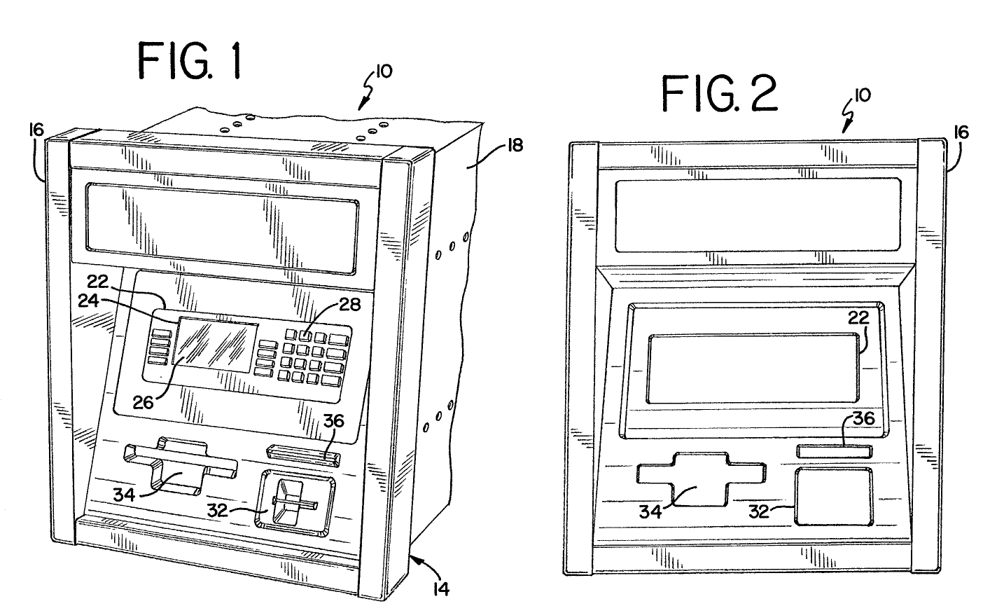

Referring now in detail to the Figures, FIGS. 1-7 illustrate a wall-mounted miniature automated teller machine (ATM) 10. The ATM 10 is mounted to and through a wall 12 (see FIG. 7).

As shown in FIG. 1, the ATM 10 has a housing 14 having a front portion 16 and a rear portion 18. Preferably, the housing 14 comprises a steel reinforcement material. The front portion 16 is fixedly attached to the rear portion 18 prior to installation of the ATM 10 in the wall 12. Preferably, the front portion 16 is welded to the rear portion 18. However, it is likewise contemplated that the front portion 16 may be attached to the rear portion 18 by any other attachment method known by those of ordinary skill in the art.

The front portion 16 has a perimeter forming a lip 20 (see FIG. 3) for abutting the wall 12 after installation of the ATM 10 in the wall 12. The front portion 16 also has a front keypad 22 connected to the housing 14. The front keypad 22 is visible on the exterior of the ATM 10. The front keypad 22 has a front screen 24 having a LED display 26, a first group of input buttons 28, and a second group of input buttons 30.

The front keypad 22 allows the cardholder to communicate with the ATM 10 and to respond to the front screen 24 prompts, such as entering transaction type and amount of withdrawal. The front keypad 22 includes a first group of input buttons, such as number buttons 28, for each number 0-9. Moreover, the front keypad 22 includes a second group of buttons, such as word buttons 30, adjacent number buttons 28. Preferably, word buttons 30 are marked cancel, change, enter and blank from top to bottom.

The front screen 24 displays prompts regarding the cardholder's transaction. The cardholder may use the front screen 24 to withdraw cash, check cash balances or transfer funds from one account type (e.g., savings) to another account type (e.g., checking). Alternatively, the ATM owner or operator may use the front screen 24 to perform management functions.

The ATM 10 also has a card reader slot 32, a tray 34 and a print-out window 36. The slot 32 allows the cardholder to insert his or her card to begin a transaction. Alternatively, the slot 32 may allow the cardholder to swipe his or her card to begin a transaction, while maintaining visible contact with the card. Constant control and visibility of the cardholder's ATM card reduces the potential for leaving cards behind after completing the requested transaction. As shown in FIG. 1, the slot 32 is horizontally-oriented. However, it is likewise contemplated that the slot 32 may be vertically-oriented, or oriented at any angle relative to the ground. The cardholder retrieves cash from the tray 34 and may obtain a receipt from the print-out window 36.

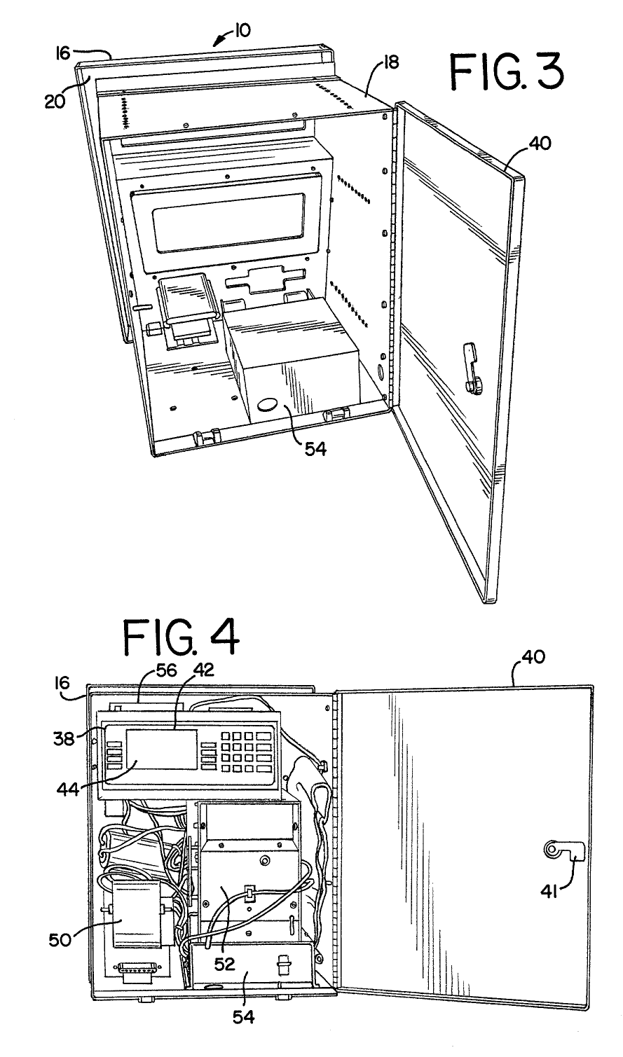

The rear portion 18 also has a rear keypad 38 connected to the housing 14. The rear keypad 38 is visible on the interior of the ATM 10 when door 40 is in a substantially open position, as shown in FIGS. 3-4. Preferably, the door 40 includes a handle 41 and comprises a ¼″ steel reinforcement material. The steel reinforcement material provides an added safety feature for the machine owner.

The rear keypad 38 has a rear screen 42 having a LED display 44, a first group of input buttons 46, and a second group of input buttons 48. The rear keypad 38 includes a first group of input buttons, such as number buttons 46, for each number 0-9. Moreover, the rear keypad 38 includes a second group of buttons, such as word buttons 48, adjacent number buttons 46. Preferably, word buttons 48 are marked cancel, change, enter and blank from top to bottom.

The rear keypad 38 is substantially identical to the front keypad 22, and the rear keypad 38 performs substantially the same function as the front keypad 22. For example, the ATM operator may perform management functions using the rear keypad 38 or the front keypad 22. Alternatively, the rear keypad 38 performs a substantially different function than the front keypad 22. For example, the ATM operator may perform management functions using the rear keypad 38, and the ATM cardholder may perform cardholder functions using the front keypad 22.

Likewise, the rear screen 42 is substantially identical to the front screen 24, and the rear screen 42 performs substantially the same function as the front screen 24. For example, the ATM operator may perform management functions on the rear screen 42 or the front screen 24. Alternatively, the rear screen 42 performs a substantially different function than the front screen 24. For example, the ATM operator may perform management functions on the rear screen 42, and the ATM cardholder may perform cardholder functions on the front screen 24.

The rear keypad 38 and the rear screen 42 operate separately from the front keypad 22 and the front screen 24. This operation allows the ATM owner or operator to perform management functions without the management functions being viewed on the front screen 24 by ATM cardholders.

As shown in FIG. 4, the ATM 10 also includes a printer 50, a cash dispenser 52 having a cash cassette 54, a modem 56, a distribution board (not shown) and a mother board (not shown). The ATM owner or operator must have access to the printer 50 to keep a roll of paper in the ATM 10 at all times in order for the cardholder's receipt to be printed at the time of the transaction. The ATM owner or operator must also have access to the cash dispenser 52 to maintain a supply of cash in the cash casette 54 in order to facilitate cash withdrawals at the ATM 10 by cardholders. Accordingly, the printer 50 and the cash cassette 54 are removable to allow the ATM owner or operator easy access to change paper or add cash.

The modem 56 allows the ATM 10 to communicate the requested transaction type, transaction amount and the cardholder information to the applicable processor and processing networks contracted with the ATM owner. The distribution board transmits power to each of the necessary components of the ATM 10, and the mother board performs the thinking for the ATM 10.

The ATM owner or operator is able to press the appropriate keys in order to program the ATM 10 with its specific parameters and to download the ATM 10 with the processor information through a telephone line via the modem 56. Specifically, the ATM owner or operator may access and program the following: enter and modify operator passwords and security levels, enter the number of documents (bills) in the cash dispenser 52, activate the bill counter option, print detailed transaction history reports including number of bills remaining in the cash dispenser 52, modem type and speed, terminal identification number (assigned by processor), download telephone number (processor phone number to dial for initial upload of program and to process transactions), edit welcome screen (message seen by cardholders on the front screen 24 prior to commencement of transaction by cardholder), edit receipt message (message seen on cardholder receipt), etc.

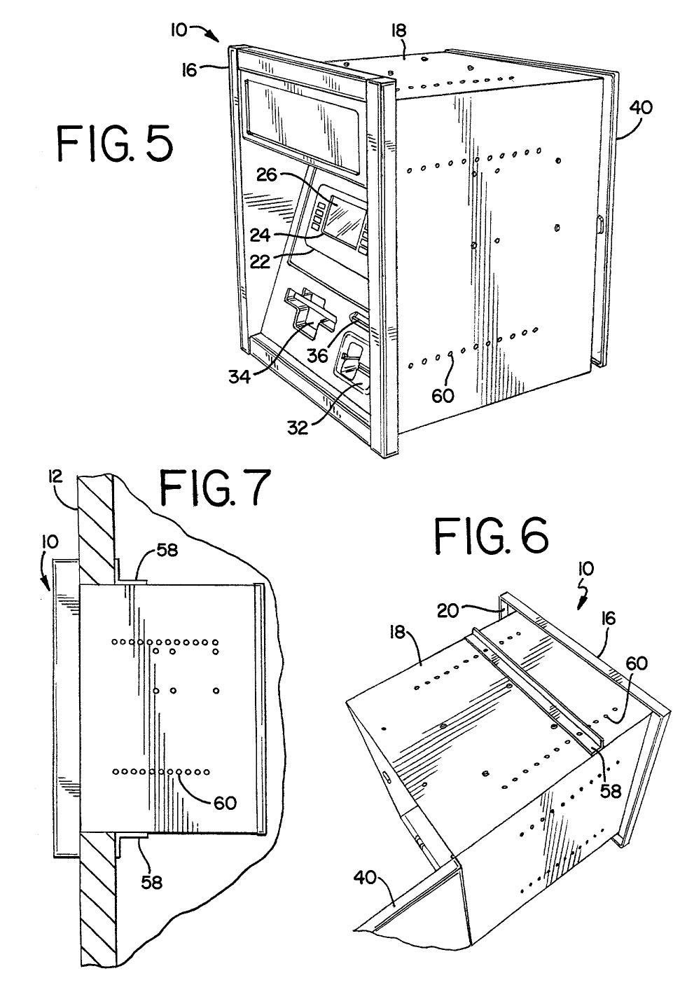

As shown in FIGS. 6 and 7, after the housing 14 is positioned within the wall 12 so that the lip 20 abuts the wall 12, a mounting angle 58 is attached to the rear portion 18 of the housing 14 for securing the housing 14 within the wall 12. Bolts, or other fastening devices, may be inserted through apertures 60 to secure the mounting angle 58 to the rear portion 18 of the housing 14. Preferably, the housing 14 includes one mounting angle 58 attached to each of the four sides of the rear portion 18 of the housing 14. However, it is likewise contemplated that any number of mounting angles 58 may be attached to each side of the rear portion 18 of the housing 14.

In operation, a cardholder swipes one of the following types of cards through the magnetic card reader slot 32: an ATM debit card, a credit card (Visa, MasterCard, American Express or discover), or an Electronic Benefits Transfer Card (EBT in select areas). The front screen 24 prompts a cardholder to enter his or her four digit personal identification number (PIN) assigned by his or her bank.

The cardholder selects the type of transaction desired: withdraw cash, balance inquiry or balance transfer. If the cardholder chooses to withdraw cash, the ATM 10 prompts the cardholder to choose the type of account the cash is to be withdrawn from: a checking account, a savings account or a credit card cash advance.

If the cardholder chooses a balance inquiry, the ATM 10 prompts the cardholder to choose the type of account to inquire about: checking, savings or credit card. If the cardholder chooses a balance transfer, the ATM 10 prompts the cardholder to choose the type of account where the funds will be debited and the type of account where the funds will be credited.

If the cardholder selects the withdraw cash or the balance transfer options, the ATM 10 prompts the cardholder to enter the amount of money desired to withdraw or transfer. The front screen 24 states in what increment the cash may be withdrawn and also states the maximum amount that may be withdrawn during one transaction. For the withdraw cash option, the front screen 24 will state that the owner or operator of the ATM 10 has assessed a surcharge amount to the cardholder for each withdrawal and provides the cardholder with an opportunity to opt out of the transaction at that time.

If the cardholder chooses to complete the transaction, the ATM 10 will communicate the requested transaction type, the transaction amount and the cardholder information to the acquiring processor, such as Concord, Core Data, etc., subscribed to by the ATM owner through the telephone lines via the modem 56 inside the ATM 10. The processor's computer mainframe system is connected to all the major networks, such as Cirrus, Plus, etc., which accesses databases on all cardholder accounts to determine if the cardholder has utilized a card that has an open account and has sufficient funds to process the requested transaction. If the transaction requested is approved, the cardholder's account is debited for the amount of cash requested plus any surcharge. The processor then collects these amounts from the cardholder's bank and reimburses the ATM owner and/or operator for the full amount of the settlement funds (amount of cash withdrawn) in addition to any surcharge amounts collected, within 1-2 business days.

If the cardholder selects a cash withdrawal and the cardholder has sufficient funds in its account, the transaction is processed and the ATM 10 dispenses the requested amount of cash from the cash dispenser 52 and sends the cash to the tray 34 for the cardholder to retrieve. For each transaction type, once the transaction is complete, the ATM 10 will print a receipt for the cardholder at the print-out window 36, listing the details of the transaction.

The miniature ATM of the present invention is thus, suspended in the air behind a wall, without the need for any traditional pedestal used when prior miniature ATMs were located in a customer area.

While the specific embodiment has been illustrated and described, numerous modifications come to mind without significantly departing from the spirit of the invention, and the scope of protection is only limited by the scope of the accompanying Claims.

1. A miniature automated teller machine, comprising:
a housing having a front keypad operably connected to the housing and a rear keypad connected to the housing,
wherein the front keypad having a front screen attached to the front keypad, and the rear keypad having a rear screen attached to the rear keypad,
wherein the rear screen allows an operator of the machine to perform management functions without the management functions being viewed on the front screen by a user of the machine; and
a door hingedly connected to the housing.

2. The machine of claim 1 wherein the housing includes at least one mounting angle attached to the housing for securing the housing within an enclosure.

3. The machine of claim 2 wherein the housing includes at least one mounting angle attached to each side of the housing for securing the housing within the enclosure.

4. The machine of claim 1 wherein the housing comprises a steel reinforcement material.

5. The machine of claim 1 wherein the rear keypad is substantially identical to the front keypad.

6. The machine of claim 5 wherein the rear keypad performs substantially the same function as the front keypad.

7. The machine of claim 5 wherein the rear keypad performs a substantially different function than the front keypad.

8. The machine of claim 1 wherein the rear screen is substantially identical to the front screen.

9. The machine of claim 8 wherein the rear screen performs substantially the same function as the front screen.

10. The machine of claim 8 wherein the rear screen performs a substantially different function than the front screen.

11. The machine of claim 1 wherein the door includes a handle.

12. A wall-mounted miniature automated teller machine for mounting the machine to and through a wall, the machine comprising:
a unitary housing having a front portion and a rear portion, the front portion being fixedly attached to the rear portion,
the front portion having a perimeter forming a lip for engaging the wall upon installation of the machine, wherein the front portion further having a front keypad including a front screen,
the rear portion having a rear keypad including a rear screen, wherein the rear screen allows an operator of the machine to perform management functions without the management functions being viewed on the front screen by a user of the machine; and
a door hingedly connected to the housing.

13. The machine of claim 12 wherein the housing includes at least one mounting angle attached to the rear portion for securing the housing within the wall upon installation of the machine.

14. The machine of claim 12 wherein the housing includes at least one mounting angle attached to each side of the rear portion for securing the housing within the wall upon installation of the machine.

15. The machine of claim 12 wherein the housing comprises a steel reinforcement material.

16. The machine of claim 12 wherein the rearkeypad is substantially identical to the front keypad.

17. The machine of claim 16 wherein the rear keypad performs substantially the same function as the front keypad.

18. The machine of claim 16 wherein the rear keypad performs a substantially different function than the front keypad.

19. The machine of claim 12 wherein the rear screen is substantially identical to the front screen.

20. The machine of claim 19 wherein the rear screen performs substantially the same function as the front screen.

21. The machine of claim 19 wherein the rear screen performs a substantially different function than the front screen.

22. The machine of claim 12 wherein the door includes a handle.
